(19) United States
(12) Patent Application Publication
(10) Pub. No.: US 2018/0021671 A1
(43) Pub. Date: Jan. 25, 2018

(54) Scavenger Treasure Hunt Software Application

(71) Applicants: Brian T. Liesenfelt, Coconut Creek, FL (US); Neal N. Klein, Delray Beach, FL (US)

(72) Inventors: Brian T. Liesenfelt, Coconut Creek, FL (US); Neal N. Klein, Delray Beach, FL (US)

(21) Appl. No.: 15/655,867

(22) Filed: Jul. 20, 2017

Related U.S. Application Data
(60) Provisional application No. 62/364,654, filed on Jul. 20, 2016.

(51) Int. Cl. A63F 13/216; A63F 13/67; G07F 17/32; A63F 13/65

(52) U.S. Cl. CPC A63F 13/216; A63F 13/65; A63F 13/67; G07F 17/3244; H04M 1/72544

(57) ABSTRACT

A software application includes a game server for a plurality of users to compete for real-world prizes over a pre-established timeframe. Users are able to download the software application to their devices, for instance on their mobile phones. Once downloaded, the user registration is recorded and the user's GPS location can be logged. Users are compiled into competitive groupings and competition commences following the competitive gaming criteria being met. During the competition, the user's GPS location may be tracked and their collection of in game electronic media may be recorded. At the end of the competition, the user with that most successfully meets the competitive gaming criteria is awarded real-world prize money. After the award of the real-world prize money is made, the game is no longer viable, and future competitors must download the new game and pay a new download fee.

### CROSS-REFERENCE TO RELATED APPLICATIONS

This application claims the benefit of U.S. Provisional Application No. 62/364,654, filed Jul. 20, 2016.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to methods for monetizing augmented reality software.

### Description of the Related Art

A mobile app is a software application (app) designed to run on mobile devices such as smartphones and tablet computers. Apps that are not preinstalled are usually available through distribution platforms called app stores. Apps began appearing in 2008, and are typically operated by the owner of the mobile operating system. Some apps are free, while others must be bought. Usually they are downloaded from the platform to a target device, but sometimes they can be downloaded to laptops or desktop computers.

Typically, commercial mobile games use one of the following monetization models: pay-per-download, subscription, free-to-play (or advertised-supported). Today, a number of new business models have emerged which are often referred to as “freemium”. The game download itself is typically free and then revenue is generated after download either through in-app transactions or advertisements.

Many games today are location-based games. A location-based game (or location-enabled game) is a type of pervasive game in which the gameplay evolves and progresses via a player's location. Thus, location-based games must provide some mechanism to allow the player to report their location, frequently this is through some kind of localization technology, for example by using satellite positioning through GPS.

Urban gaming (or street games) are typically multi-player location-based games played out in city streets and built up urban environments. Various mobile devices can be used to play location-based games; these games have been referred to as “location-based mobile games”, merging location-based game and mobile games. Examples of such games include GEOCACHING®, BOTFIGHTERS, INGRESS®, and POKÉMON GO®.

### BRIEF SUMMARY OF THE INVENTION

It is an object of the invention to provide a game server that overcomes the disadvantages of the devices and methods of this general type and of the prior art.

An object of the invention is to provide a game server supporting a software platform for users to play computer games for real-world prizes.

The scavenger treasure hunt software application provides users with a game server to allow the users to register for competitions.

An object of the invention is to provide access to a multiplicity of mobile users of the software application on differing platforms. The scavenger treasure hunt software application is available in multiple platforms for multiple devices, including IOS and ANDROID devices. The user of the scavenger treasure hunt software application is able to download the software application from their respective app store. Once downloaded, the user is registered. Registered users elect to join differing competitions, where they compete against other registered users.

An object of the invention is to establish gaming criteria for differing competitions. Registered users are able to join these competitions. The scavenger treasure hunt software application compiles users into different competitive groupings. Once the competitive gaming criterion is met, the competition commences. Such criteria may be preset available spots for registered users to compete. Once these spots are filled, the competition starts for a preset timeframe.

The preset timeframe may be any variable time increment. The time increment may be rapid rounds, being as little as an hour. The time increment may be over an extended timeframe, such as multiple months. Registered users are able to position themselves in differing competitions based on their preference. The user's preference may be to join, and solely play the rapid rounds in order to have the possibility of quick financial reward. The user may also join varying competitions such as joining a rapid round competition and then joining an extended time competition.

It is an object of the invention to be capable to interact with user's real-world GPS location in order to enable location-based competition. In embodiments with location-based capabilities, registered users' GPS locations are logged in order to allow for real-world location being coordinated with in-game location, which allows for accurate location-based augmented reality competition.

The location-based augmented reality competition records users in game collection of electronic media, based on their GPS location. When the competition ends the user best meeting the competitive gaming criteria wins the real-world prize.

It is an object of the invention to provide a platform for users of mobile devices to play games for real-world prizes. These real-world prizes may be in the form of real-world currency. “Real-world currency” is money that is able to be used in today's market to purchase physical products. By rewarding winners of competitions with real-world currency, users the games will be enticed to register themselves through the scavenger treasure hunt software application to play. Instead of simply playing the game for personal satisfaction, users of the scavenger treasure hunt software application will be rewarded with both personal satisfaction as well as financial reward.

It is an object of the invention to entice users to repeatedly use the scavenger treasure hunt application. One way to entice repeated users is by providing for users to work their way up various levels. The various levels are met through winning competitions, and collecting in game electronic media. The scavenger treasure hunt software application may compile groupings of users in separate competitions based upon their level. Higher level users may be able to play for larger prizes. Users will repeatedly use the scavenger treasure hunt software application in order to level up and play for the larger prizes.

In the preferred embodiment, the scavenger treasure hunt software application is a video game for a defined timeframe, with an initial purchase price, and a reward of real-world currency at the end of the game to the winner. Users of the scavenger treasure hunt software application may download the application, pay a download fee, and, in location-based gaming, agree to share their GPS location with the software application. The scavenger treasure hunt software application sets the competitive gaming criteria, including at least one of the following factors: number of users to be included in the competition, GPS location of the user, timeframe that the competition will span, goal number of electronic media to collect, and skill level of the users. The recorded collection of in game electronic media, by which the user will be scored, may include items such as, digital characters, or any other associated collectables which may be used to keep score within the game.

Once the competitive gaming criteria is set, the game commences and ends within the set competitive gaming criteria. In the preferred embodiment, the user with the most collected electronic media wins.

An additional aspect of the invention is that the winnings are in real-world currency. The supply of real-world currency is in a pool, provided for by the software application. This pool is non-gambling money, and is preset based on the competition level.

To encourage participation, the scavenger treasure hunt software application offers increased levels to users that have previously won. The users with higher levels are able to join competitions that remain unavailable to users at lower levels. The users playing in higher level competitions are able to pursue higher real-world currency awards than users in the lower level competitions.

In the preferred embodiment, the timeframe for the competitions may vary. The scavenger treasure hunt software application offers both rapid rounds and extended rounds. The rapid rounds may be completed within as little as an hour, and the extended rounds may extend for a period of multiple months. Different users may prefer different timeframes of competition, and thus the scavenger treasure hunt software application provides differing timeframes to accommodate different users.

In the preferred embodiment, the scavenger treasure hunt software application is used to encourage participation. Instead of simply feeling emotional satisfaction from achieving differing accomplishments within the basic pre-existing games, the scavenger treasure hunt software application provides real-world monetary compensation to users as well as the emotional satisfaction that was previously provided. The exchange for this real-world monetary compensation is provided in exchange for a small fee associated with the downloading of the software application.

At the end of the competition, after the winner is paid, the scavenger treasure hunt software application is no longer viable. Users wishing to continue to compete must go back to their respective app store and download the new version of the scavenger treasure hunt software application. When downloading the new version of the scavenger treasure hunt software application, the user must again pay the associated download fee. The new version may have a new set of competitive gaming criteria, with differing timeframe and reward.

Other features that are considered as characteristic for the invention are set forth in the appended claims.

Although the invention is illustrated and described herein as embodied, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a process flow diagram of a scavenger treasure hunt software application according to the invention.

FIG. 2 is a data flow diagram illustrating data processing of competitive gaming criteria according to the invention.

FIG. 3 is a schematic view of a system according to the invention.

FIG. 4 is a front side view of a mobile telephone.

FIG. 5 is a rear side view of the mobile telephone shown in FIG. 4.

FIG. 6 is a perspective view of a mobile telephone being used to execute an augmented reality application.

### DETAILED DESCRIPTION OF THE INVENTION

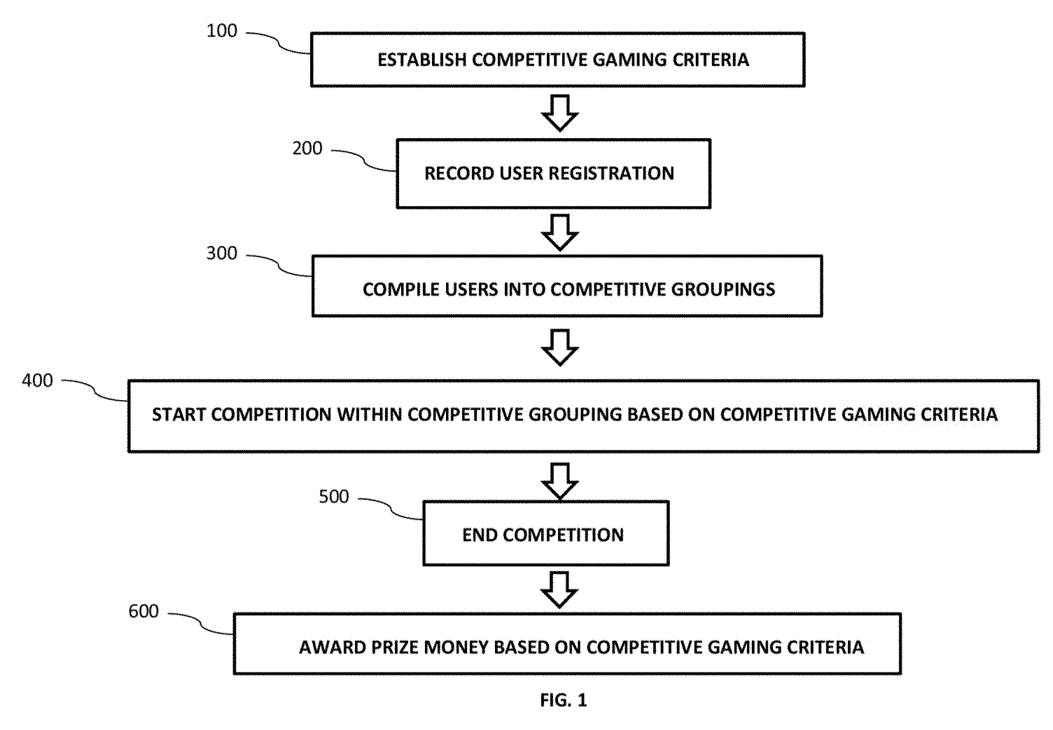

FIG. 1 is a process flow diagram illustrating a scavenger treasure hunt software application. An establishment of competitive gaming criteria is achieved 100. Then individual user registration is recorded 200. The registered users 200 are compiled into competitive groupings 300. Competition starts 400 within competitive grouping 300 when competitive gaming criteria 100 is first met. The competition ends 500 when the competitive gaming criterion 100 is finalized. Prize money is awarded 600 based on competitive gaming criteria 100 being most successfully met.

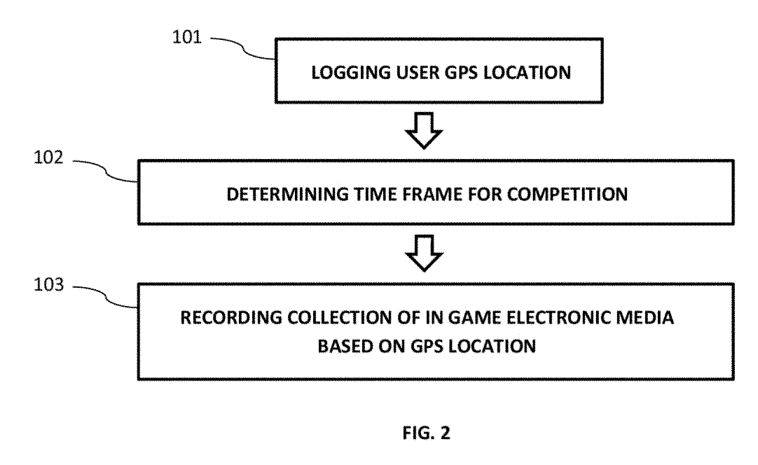

FIG. 2 is a data flow diagram of the competitive gaming criteria 100, as shown in FIG. 1. Competitive gaming criteria 100 may incorporate logging of differing GPS location 101, which can later be used to compile users into competitive groupings 300. The timeframe for the competition is set 102, the award of the prize money 600 may follow the expiration of the set timeframe 102. The user's collection of in game electronic media, which may be based on GPS location, is recorded 103 during the time period after the start of the competition 400 and prior to the end of the competition 500. The recorded collection of in game electronic media 103 is used to determine which user within the compiled grouping 300 is awarded the prize money 600. The recorded collection of in game electronic media 103 may trigger the end of the competition 500.

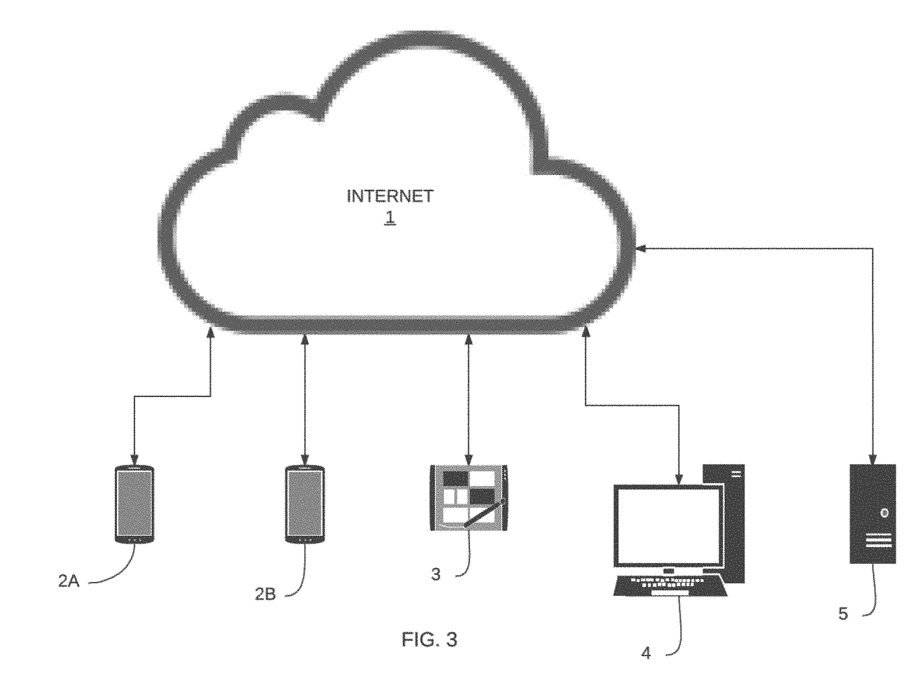

FIG. 3 shows a preferred embodiment of a system according to the invention. A wide area network known as the Internet 1 provides a network to which computers can interconnect. A first smartphone 2A and a second smartphone 2B are connected to the Internet 1. A computerized tablet 3 is connected to the Internet 1. A desktop computer 4 is connected to the Internet 1. A server 5 is connected to the internet. In a preferred embodiment, a large number of computers are connected to the server to allow a plurality of players to participate in the competition.

The server 5 hosts data relating to competition 500 including GPS locations 101, the timeframe 102 of the competition.

The various computers, including the smartphones 2A, 2B, tablet 3, computer 4 run an application that connects to the server 5 and exchanges data with server 5.

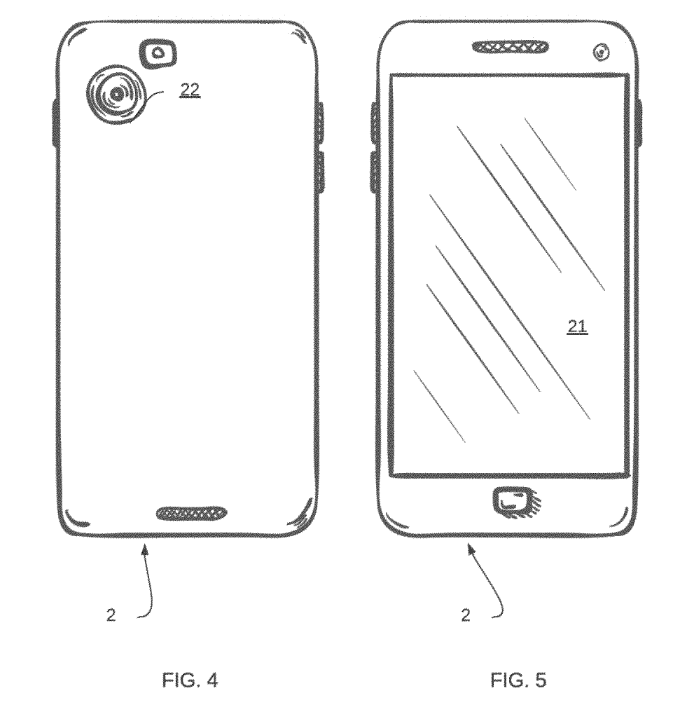

FIGS. 4-5 show a smartphone 2. A camera 22 is disposed on the back of the smartphone 2. A touchscreen display 21 is disposed on the front of the smartphone 2. Images and video being recorded by the camera 22 are displayed on the touchscreen display 21.

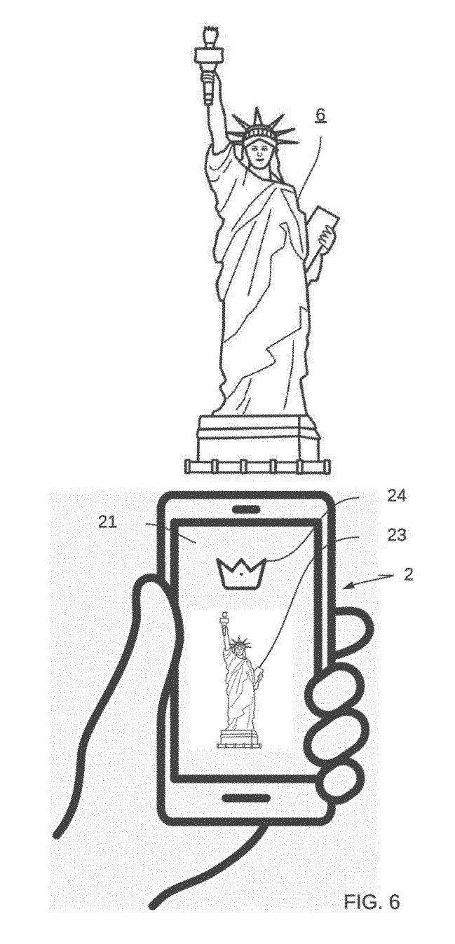

FIG. 6 shows a preferred embodiment of a competition being run on a smartphone 2. A subject 6 is being recorded with the camera 22 (see FIGS. 4-5) and shown on the display 21 as an image 23. An augmentation 24 is added in the display 21 by the application running in the smartphone 2. The augmentation 24 is being displayed based on GPS data being sent by the smartphone 2 and image recognition software running in the application. When the augmentation 24 is being displayed, the user can touch the touchscreen display 21 to capture an augmented image, which is then sent to the server 5 for use in the competition.

The preferred embodiments provided herein are used to illustrate and provide examples of the invention. However, the preferred embodiments should not be read to limit the invention that is described by this specification and claims.

What is claimed is:

1. A software implemented method for awarding a prize for a competition, which comprises:
establishing a competitive gaming criterion for winning the competition;
receiving data from each user of a plurality of users, said data describing said respective user;
transmitting said data to a server;
compiling said plurality of users into competitive groupings;
commencing a competition within each of the competitive groupings;
ending the competition in one of the said competitive groupings when said competitive gaming criterion is met by one of said plurality of users in said one of said competitive grouping; and
awarding real-world monetary compensation to said one of said plurality of users in said one of said competitive groupings.

2. The software implemented method according to claim 1, wherein said competitive gaming criteria includes:
receiving data including a GPS location of the user;
determining a timeframe for a period of competition; and
recording collection of in-game electronic media based on said GPS location.

3. The software implemented method according to claim 2, wherein said competitive gaming criteria includes a categorical skill level of the user.

4. The software implemented method according to claim 2, wherein said ending of the competition is tolled when the determined timeframe expires.

5. The software implemented method according to claim 2, wherein said ending of the competition is tolled when a determined goal of said recorded collection of in game electronic media is met.

6. The software implemented method according to claim 2, wherein said determined timeframe for the period of competition is a period of an hour.

7. The software implemented method according to claim 2, wherein said determined timeframe for the period of competition is a period of a multiplicity of hours.

8. The software implemented method according to claim 2, wherein said determined timeframe for the period of competition is a period of a month.

9. The software implemented method according to claim 2, wherein said determined timeframe for the period of competition is a period of a multiplicity of months.

10. The software implemented method according to claim 1, wherein said award of monetary compensation is a variable factor changing with each competition.

11. The software implemented method according to claim 1, wherein said game is no longer viable once award of real-world currency is made.

12. A software implemented game system, comprising:
a controller for operating a gaming platform, said controller being configured for:
storing data on a gaming server, said data being related to a game;
compiling users into competitive groupings in a plurality of competitions; and
each of said competitive grouping including at least two users for competing in competition for a reward of monetary compensation, and said monetary compensation being preset by said gaming server.

13. The software implemented game system according to claim 12, wherein said gaming platform is a location-based augmented reality mobile game.

14. The software implemented game system according to claim 12, wherein said reward of monetary compensation is a non-wager pool based system.

15. The software implemented game system according to claim 14, wherein said non-wager pool based system is a set amount paid for by said gaming server.

16. The software implemented game system according to claim 12, wherein the user pays a download fee for a registration number.

17. The software implemented game system according to claim 12, wherein said reward of monetary compensation is awarded to the user within said competitive grouping with a majority of collected in game electronic media.

18. The software implemented game system according to claim 17, wherein said majority of collected in game electronic media is a variable dependent on GPS location.

19. A software implemented game system, comprising:
a controller for operating gaming platform, said controller being configured for a user to make use of:
a gaming server for storing data related to a game;
a plurality of competitions for compiling the users into competitive groupings; and
each of said competitive grouping includes at least two users for competing in competition for a reward of monetary compensation, said monetary compensation being preset by said gaming server.

20. The software implemented game system according to claim 19, wherein said gaming platform is a location-based augmented reality mobile game.

21. The software implemented game system according to claim 19, wherein said reward of monetary compensation is a non-wager pool based system.

22. The software implemented game system according to claim 21, wherein said non-wager pool based system is a set amount paid for by said gaming server.

23. The software implemented game system according to claim 19, wherein the user pays a download fee for a registration number.

24. The software implemented game system according to claim 19, wherein said reward of monetary compensation is awarded to the user within said competitive grouping with a majority of collected in game electronic media.

25. The software implemented game system according to claim 19, wherein said majority of collected in game electronic media is a variable dependent on GPS location.

26. The software implemented game system according to claim 19, wherein said game is no longer viable once award of real-world currency is made.

27. A method for receiving prize money for winning a scavenger hunt game, which comprises:
buying a game application, said game application being associated with a player;
installing said game application on a computer of said player, said computer including a camera, and a network interface controller;
taking a photograph of the target with the camera;
connecting to a server with the network interface controller;
transmitting the photograph to the server via the network interface controller; and
receiving a cash prize when the player is the winner.
